(19) United States
(12) Patent Application Publication
(10) Pub. No.: US 2005/0163001 A1
(43) Pub. Date: Jul. 28, 2005

(54) Device for feedback control of a digital audio apparatus from a monitoring record turntable support

(76) Inventor: Pascal Otalora, Lunel (FR)

Correspondence Address: Pascal Otalora, 204 Rue Tivoli, Lunel, 34400, FR

(21) Appl. No.: 10/498,459

(22) PCT Filed: Nov. 25, 2002
(86) PCT No.: PCT/FR02/04026

(30) Foreign Application Priority Data
Nov. 23, 2001 (FR) 01/15330

(51) Int. Cl. G11B 5/09

(52) U.S. Cl. 369/47.15

(57) ABSTRACT

This invention concerns a device for feedback control of a digital audio apparatus, from a monitoring record support turntable. The turntable is that of a fine groove record player equipped with a transducer, the monitoring record (101) comprises a fine groove (102) with at least one track which is closed at least partly on itself in a loop, to deliver continuously cyclic data from a uniformly asymmetric signal provided along the track of at least one groove, for feedback control of the digital audio apparatus in playing sped in accordance with the playing speed of the uniformity of the monitoring record signal as well as in the playing direction in accordance with the configuration of the signal of the monitoring record gradually played in one direction or other of said signal by the transducer of the fine groove record player.

This invention dealing with the treatment of sound information based on a relative movement between recording device and a transducer. It aims to servo control a numerical audio device, using a rotating tray supporting a driving disk.

It is stated that musical arts consist in using a recorded sound track on a LP to create music by playing the sound track by an operator who is using the recording device in order to vary the direction and the speed of the recorded sound track with a transducer.

The evolution of the techniques of those recording devices ended the use of the LP replaced by disk with numerical information. The structures which read those numerical information can not be used as the musical art described above. Others proposed servo control device between a manly operated CD player and a numerical reader device through which the sound is emitted.

Generally those servo controls are made of a driving disk which can rotate and can be manipulated by an operator.

The driving disk is associated with communication tools which are related to speed and direction of rotation which are related with a device which deals with the information in order to control a numerical audio device.

To play, a musician can use a LP player on which he installs the driving disk and a numerical audio device on which he installs the sound disk. Then the player put between those two devices the device that treated the information coming from the driving disk to servo control the numerical audio device depending on the moves it creates on the rotating disk player.

The first constraint to be noticed at this stage of the description is for a travelling musician to have to install his equipment on a place where quickly two readers are already installed.

This first type of devices proposed use optical reading communication. These communications systems include sequential information dispatched as a loop around the driving disk and optical reading devices to read that information. Documents GB 2361348 (F0RD SIMON ANDREW) and WO 9701 168 (RICKLY ANDRE) are available for more information about this type of devices.

A major disadvantage of these devices is for the musician to have to fit on the LP player some optical reading devices, this disk transducer being neglected. Moreover, reliability and performances of the numerical reader servo control by the sequential information include in the driving disk are not acceptable, especially because of an under exploitation of the numerical reader capacities being dependent of the optical communication devices.

Nevertheless one of this first devices advantage is the loop disposition of the information around the disk, allowing a numerical reader servo control unlimited in time. In order to overcome the disadvantage described earlier, a second type of devices has been proposed.

In these devices, the communication devices use the LP player transducer to read the information included on the driving disk. These information are numerical. They are formed from a continuous signal spread on the disk all along a LP. This LP includes two tracks used for the communication of the reformation related to both rotating ways of the driving disk.

The signal of each one these tracks is a signal corresponding to a chronometrical code known as “Time-code”.

This signal enables to put together the playing mode of the numerical audio device and the playing mode of the driving disk, by comparing chronometric sequences between both relative positions at a precise moment. One can refers to the patent WO 016559 (BASTIAN) which describes the same device as the second type one.

Although those devices can overpass many inconvenient of the first type's devices, enabling to exploit strictly the transducer of the LP player to read the driving disk, it has many majors inconvenient.

Firstly the player has to initiate the reading mode of the driving disk before using it.

Secondly the exploitation of the driving disk is limited in time due to the spiral track of the LP and the signal inside. It is to note that some musical tracks can last more than an hour. That length disabled the use of the device because he cuts the reading of the numerical device.

Thirdly if the liaison between the transducer of the LP player and the driving disk is broken, due to a malfunction in the transducer's carrying axle, the sound signal will be broken too.

All the more that the musical art is linked to sound and visual effect associated with the manipulation of the driving disk.

Those effects are produced by specialists such as lighting technicians and sound engineers which means that they have to work hands in hands with the driving disk's operator.

Finally, another general problem given lies in the fact of it is frequent that the operator who acts the driving disk, associates a couple of sounds disks drives to make the musical art as previously said, and that some instruments like potentiometers, allowing to modify the sound effect products. It engenders that the operator should be concentrate simultaneously on a lot of things to do.

The general goal of this present invention is to propose a system like this one previously describes of subjection of an audio numerical apparatus, start from a swivel platter which is a support of a driving disk, who counters a group of conveniences relative to devices corresponding to the first and second types previously mentioned.

Another goal of this present invention is to propose a such system who allows to make easier the collaboration between the operator who handles the driving disk and others workers like electrician or sound engineer.

Another goal of this present invention is to simplify the intervention of the operator on the driving disk, to make easier for him the execution of this manipulation with regard to the group of tasks he must to do.

The system of this present invention is a system of subjection of an audio numerical apparatus. We will understand that this apparatus is a multimedia apparatus, because it's an apparatus coming within any numerical standard. This subjection is realised starting from a driving disk allowing to be carried away in rotation by a swivel platter which supports him and which is manipulated by the operator. The driving disk is associate at some ways of communication of information relative to his speed and his direction of rotation, which are in relation with an information processing apparatus, to drive the audio numerical system.

The system of this present invention is principally recognisable because the swivel platter is this one of a microgroove disk player fitted with a transducer, as mobile magnet cartridge type or diamond type.

The driving disk comprise a fine groove with at least one channel, which is closed at least partially on itself in a loop, to deliver in continuous the cyclic information. The signal designed along at least one channel of the fine groove is a signal regularly asymmetric, to drive the numeric audio device, firstly in playing speed in accordance with the speed playing of the regularly of the driving disk signal, and secondly in the playing direction according to the format of the driving disk signal played in one direction or in the opposite direction read by the fine groove disk player transducer.

It principally results of this:
1) That the driving disk is able to be read by a transducer carried by a mobile harm equipping a usual fine groove disc player.
2) That the driving disk can be used on a unlimited playing time from any reading place of the fine groove.
3) That the driving disk could be used continuously to drive the numeric audio multimedia for the information transcription as well from a same support than from many supports alternatively and/or successively read.
4) That one useful channel is workable, leaving available at least another one channel for the execution of other complementary task in relation, as a visual effect and/or a sound effect, or even the driving of another complementary numeric audio device.

According to a first variant of realisation, the fine groove comprise two channels each comprising a signal.

The signal of one of those channels correspond to a sinusoidal signal, for the speed driving of the digital audio player, while that the signal of the other channel correspond to a asymmetric signal for the playing direction driving of the digital audio device. However, and thanks to the signal structure used for the driving of the digital audio player, it is preferred another variant according which the fine groove comprises one channel whose the written signal is a asymmetric sinusoidal signal workable by itself for the feedback control of the digital audio device, as well concerning its sped than its direction of rotation.

A such variant presents the advantage to make possible a preferred form of realisation of the invention device, according to which the fine groove comprises two channels, the signal of each of those channels being an asymmetric sinusoidal signal for an alternative exploitation of those channels in the case of malfunction of any of it, what is pragmatically usual by utilisation condition of the audio equipment in order to realised the musical art previously said.

A such variant present as more over the advantage to make possible the affectation to one of the channels the driving of the audio numeric device, and at the other channel the driving of at least one complementary digital device in anticipation the its synchronised working.

The complementary numeric device is for example any of the effect generator device associated comprising sound effects, as reverb, echo, distortion or similar, visual effect, of lighting for example, and the driving of a complementary digital audio player.

We will note that the driving of the complementary digital audio player is by preference associated with a commutation way for the selection of the activation and or for the selection of one digital device among many complementary associated digital audio players.

We will note that the sinusoidal of the signal presents by preference a significant permanent value to avoid the lost of this signal by the transducer of the fine groove disk.

We will note finally that the digital audio device is at least one of both playing device and recording device.

The present invention will be better understood, and details will appear, at the description which will be done by the preferred realisation mode, in relation with the annexed figures on which:

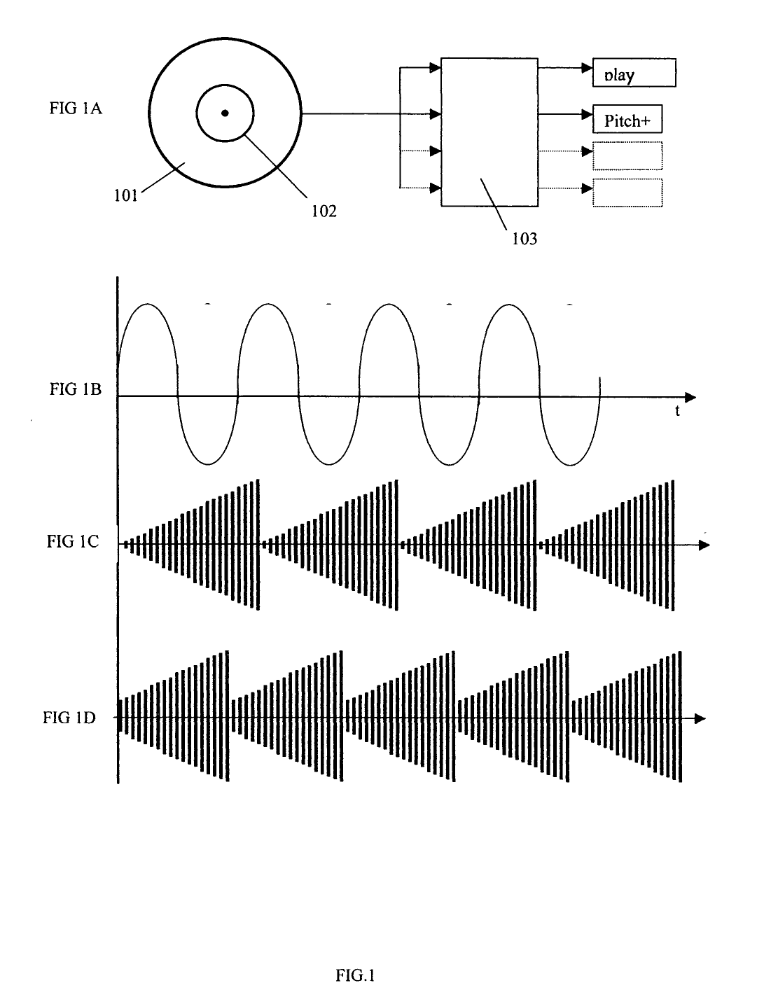

The FIG. 1A is a diagram of a device of the present invention, according to an example of realisation.

The FIGS. 1B to D represent the chronogram corresponding to the information carried by a driving disk participant at the device represented on the FIG. 1.

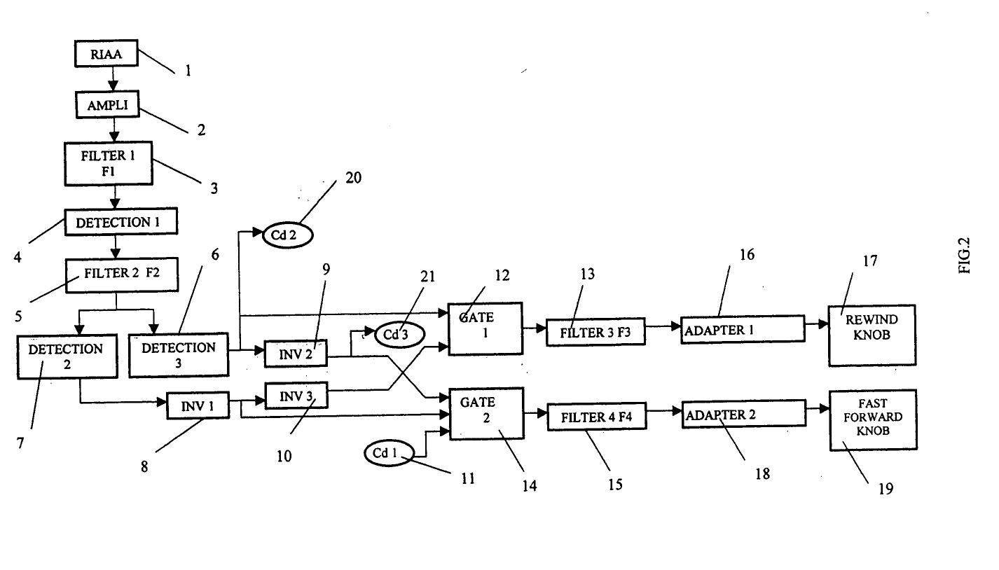

The FIG. 2 is a functional diagram of the device represented on the FIG. 1, which represents the circuits of one interface of the device represented on the FIG. 1A, corresponding to a direction of rotation detection of the mechanical support.

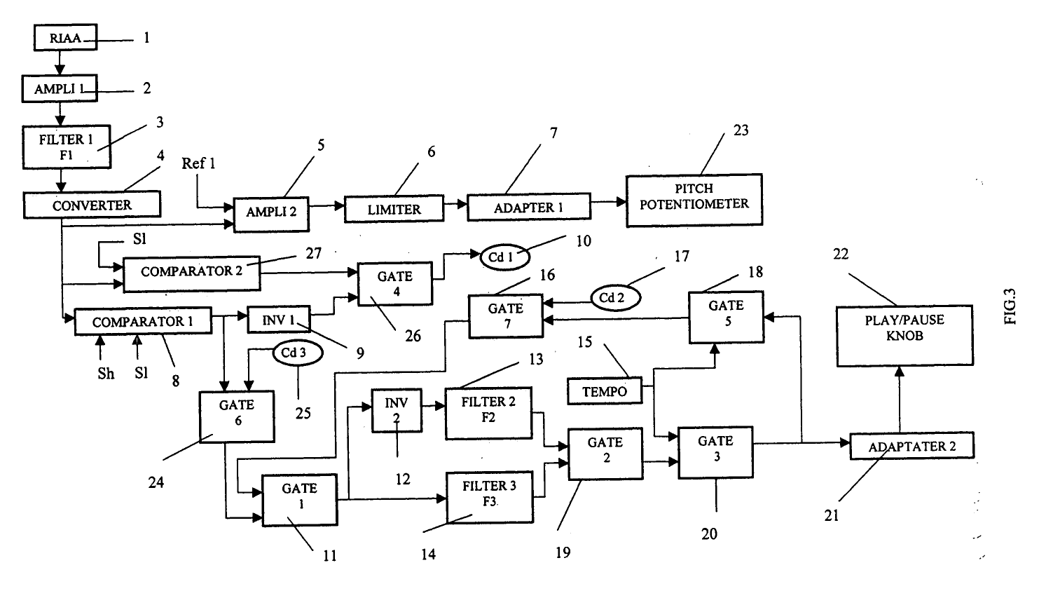

The FIG. 3 is a functional diagram of the device represented FIG. 1, which represents the circuits of one interface of the device represented on the FIG. 1A, corresponding to a speed research detection.

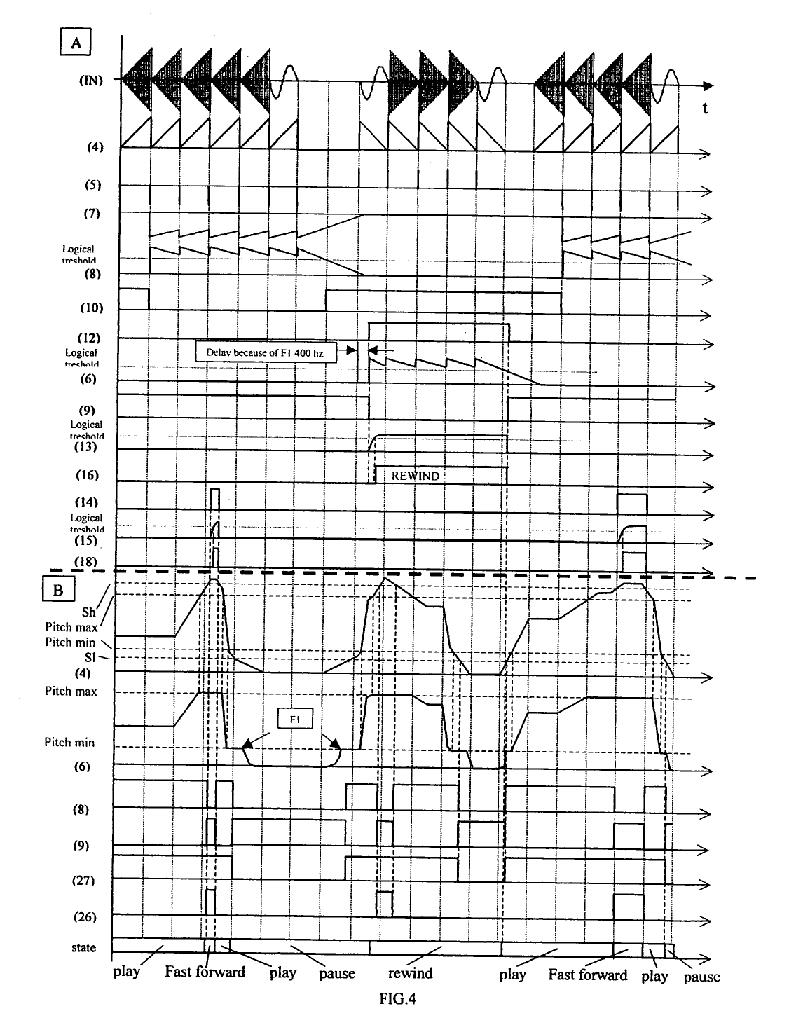

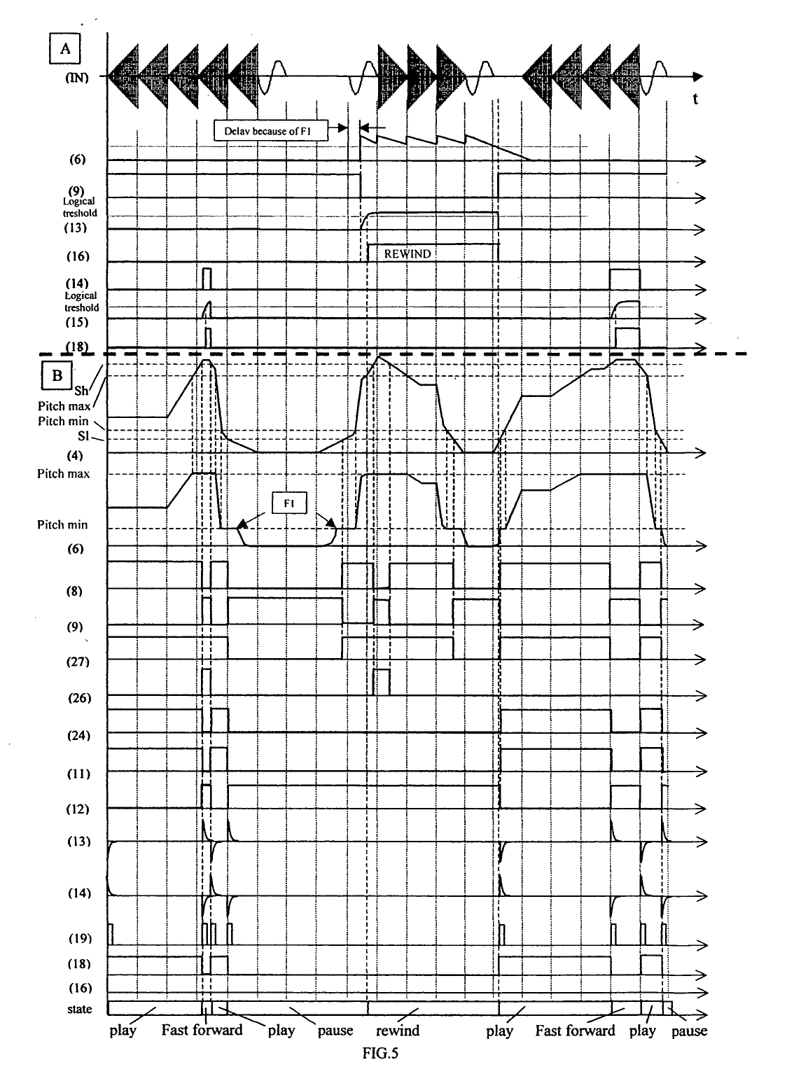

The FIG. 4 and FIG. 5 represent the chronogram of the signals circulating in the modules of the device represented on the FIG. 1 and illustrated on the FIG. 2 and FIG. 3.

On the FIG. 1A, a driving disk (101), vinyl disk by preference comprises a fine groove (102) closed on itself in a loop. We will understand that the fine groove can be circular, as illustrated or be spread in spiral on the quasi totality of the disk side and be closed on itself in a loop a its end, as the audio vinyl disc. This fine groove comprises on its whole length, and on its part closed on itself in a loop, a sinusoidal cyclic signal comprising a regular asymmetric sequences as illustrated on the FIG. 1C and FIG. 1D.

The driving disk (101) is set in rotation and read by a rotating support of a turntable (no represented) known by the professional. The rotating support drive the driving disk (101) in rotation with a constant speed, as long as the operator doesn't intercede with the driving disk motion, for example with a speed of 33 rotations per minute.

The player is fitted by a reading head carrying a transducer, for example with diamond, which is in contact with the driving disk (101) and which is in relation with the way of amplification of the signal coming from the transducer.

This amplified signal is significant of the signal carried by the driving disk, with in corollary liable information relative to the speed and to the direction of rotation of the driving disk. One interface, constituent one apparatus (103) of information processing provided by the transducer and by the encoded signal, decode the information contained in this signal and format a driving signal for a digital multimedia system (no shown), for example a computer equipped by a disk player or similar.

On the FIG. 1B and FIG. 1C, the information written on the driving disk (101) are “stereo”, the fine groove 102 comprising two channels: when the user doesn't act on the disk, on one channel there is a F0 frequency sinusoidal signal and continuous amplitude, illustrated FIG. 1B; on the other channel there is a continues F0sr frequency sinusoidal signal, modulated in amplitude by a continuous F0r frequency ramp shape signal and continuous amplitude illustrated FIG. 1C.

On the FIG. 1D, the fine groove (102) comprise one unique channel. It comprises a signal associating asymmetric regular sequences by one part, and the other part the sinusoidal shape of the signal.

We observe that at least one of the cyclic information comprised by the driving disk (101) is asymmetric according the signal progress along the fine groove (102), it means that it is not possible to superposed to itself its symmetric function in regard to this progress. In this manner, we can detect when the driving disk is set in movement in on direction or in the other.

The amplified signal processing apparatus is made up of two mains parts, or modules.

The device for the amplified signal processing owns two mains parts or modulus.
a) The high speed research detection module illustrated FIG. 3, and
b) The direction of rotation detection module illustrated FIG. 2.
   On FIG. 3, the sinusoidal signal drawn fig 1B get into a “RIAA” corrector 1, followed by a first voltage amplifier “AMPLI1” 2 then pop trough a first high pass filter “FILTRE1” 3 which has a cut off frequency F1. The signal feeds a converter “CONVERTER” 4 which is a frequency to voltage converter. The output of the converter “CONVERTER” 4 feeds three parts of the circuit illustrated FIG. 3:
a pitch command owning a second amplifier “AMPLI2” 5, which is a unity gain voltage amplifier in adder function in order to add a voltage offset “REF 1” to the signal provided by the converter “CONVERTER” 4. At the output of the second amplifier “AMPLI2” there is a voltage limiter “LIMITER” 6 which allows to define the range variation of the pitch. The output of “LIMITER” 6 is linked to the “ADAPTER 1” 7 to format the signal in order to switch it with the signal provided by the potentiometer of the pitch command of the multimedia 23 from the driven numeric multimedia device.

We substitute the signal provided by the potentiometer of the pitch command for the signal from the “ADAPTER 1” 7. The adapter “ADAPTER 1” 7 is not include in the invention, it will be design by the professional according to the work specification, of the signal provided by the limiter “6” and the work specification of the signal to provide at the multimedia. This adaptation concerns the shape of the signal, the polarity, the phase, the frequency, the power and the impedance. The signal provided by the adapter “7” take the place of the signal provided by the pitch tuning command element of the multimedia device to be driven.

The detection of “cd 1”: the signal provided by the converter “CONVERTER” 4 get, by a parallel link, into the first comparator “COMPARATOR 1” 8 which has two switching threshold “Sh” and “S1”, and into a second comparator “COMPARATOR 2” 27 which is a comparator which has “S1” for switching threshold. The output of the second comparator “COMPARATOR 2” 27 is at high logic level if the incoming level is above “S1” and at low logic level if the incoming signal is below “S1”. The output of the second comparator “COMPARATOR 2” 27 and the output signal of the inverter “INV 1” 9 get into the gate “GATE 4” 26 which is a “AND” gate. The output of the gate “GATE 4” 26 provide the signal “CD1” 10. The inverter “INV 1” 9 is an logic gate inverter which invert the output signal of the comparator “COMPARATOR 1” 8.
a “play/pause” command: the signal provided by the comparator “COMPARATOR 1” 8 and the signal “CD 3” 25 get into the gate “GATE 6” 24 which is a “AND” logic gate. The signal “CD 3” 25 is provided by the output of the inverter “INV 2” 9 (FIG. 2).

The signal provided by the gate “GATE 6” 24 and the “GATE 4” 26 get into the gate “GATE 1” 11 which is a “OR” logic gate. The output signal of the gate “GATE 1” 11 is sent at the same time to the inverter “INV 2” 12, which is a logic gate inverter, and the filter “FILTER 3” 14 which is a high pass filter with a cut off frequency F3. The output of the inverter “INV 2” 12 get into the filter “FILTER 2” 13 which is a differentiator filter with a cut off frequency F2. The output signals of the filters “FILTER 2” 13 and “FILTER 3” 14 get into the gate “GATE 2” 19 which is a “OR” gate by diodes circuit to recover the positives pulses. The timer “TEMPO” 15 provide a temporisation at the start up realised with a RC circuit. The gate “GATE 3” 20 is an AND logic gate receiving the output signals of the gate “GATE 2” 19 and the timer “TEMPO” 15. The adapter “ADAPTER 2” 21 formats the signal in order to take the place of this provided by the command element of the play/pause function 17 of the multimedia device to drive. The adapter “ADAPTER 2” 21 is not include in the invention, it will be design by the professional according to the work specification, of the signal provided by the limiter “6”. This adaptation concerns the shape of the signal, the polarity, the phase, the frequency, the power and the impedance. This signal takes the place of the signal 22 provided by the play/pause command element of the multimedia device to drive. The gate “GATE 5” 18 is a frequency divider by two realised with a D flip-flop, the timer “TEMPO” 15 allow to reset the gate “GATE 5” 18 at the starting sequence. The clock signal is provided by the output of the gate “GATE 3” 20. The output of the gate “GATE 5” 18 get into the gate “GATE 7” 16 which is a “AND” logic gate. The signal “CD 2” 17 is provided by the output of the detector “DETECTION 3” 6 (FIG. 2) of the direction of the rotation detection module.

In the following description, we show how are chosen the specific values of some components of the circuits shown in FIG. 3, the speed research module detection.
cut off frequency F1 calculation of “FILTER 1” 3: F1 is the low cut off frequency and its value is smaller than F0.
Neutral pitch calibration for F0:

When the mechanical support, or vinyl disk, is played with a neutral pitch, the sinusoidal signal frequency equals F0. This frequency must also match a neutral pitch reading of the multimedia support. This calibration is realised by the tuning of the “REF 1” value. This function is realised by the amplifier “AMPLI 1” 4.

The speed playing of the multimedia audio support which has its neutral value for F0, change proportionally at F0sr.
Calibration of the pitch variation range:

Once the neutral pitch calibration done, the maximum and minimum values of the information which will be substituted to which of the multimedia pitch drivingelement must be defined. Those values define the limitation voltages for the limiter “LIMITER” 5.
Threshold calculation “Sh” and “S1” of the comparator 8:

The high switching threshold “Sh” defines the threshold above which the fast research is activated. This value is defined by experiment in order to match the conviviality wished by the user. This value can own different calibration range.

The low switching threshold “S1” defines the threshold from which the pause mode is activated.

On the FIG. 2, the sinusoidal signal modulated in amplitude by a saw tooth signal shape, first get into a “RIAA” I corrector then get into an amplifier “AMPLI” 2 which is an voltage amplifier then get into a filter “FILTER 1” 3 which is a high pass filter with a F1 cut off frequency. The signal envelope is recover by the “DETECTION 1” 4 circuit and get into the filter “FILTRE 2” 5 which is a differentiator filter with a F2 cut off frequency. The filter “FILTER 2” 5 provide voltage peaks, positives or negatives according to the playing direction of the ramp signal. Those peaks are detected according to its sign: negative by “DETECTION 2” 7 and positive by “DETECTION 3” 6. In the modules “DETECTION 2” 7 and “DETECTION 3” 6 a RC circuit provide a memory effect to the pulses in order to keep steady logic level which could be used by the following logical circuits. The capacitor C provide the memory effect between two pulses and the resistor R allowed to discharge C in the case of pulse absence. “INV 1” 8 represents a signal inverter realised with an unity gain inverter amplifier. The inverters “INV 2” 9 and “INV 3” 10 are logic gate inverters. The gates “GATE 1” 12 and “GATE 2” 14 are AND logic gate. Those AND logic gates allow the fast forward and rewind modes, according to the different parameters which are provided. Those parameters are:
The fast research command signal “CD 1” 11 provide by the output of “GATE 4” 26 from FIG. 3.
The peak sign detected by “FILTER 2” 5.
In the case of a changing of the fast research mode, for example for the transition from a fast forward mode to a rewind mode, the starting of the new mode stops the old one.

The filters “FILTER 3” 13 and “FILTER 4” 14 are low pass filters with their cut off frequency F3 and F4. Those two filter own a diode which allows the low logic level quickly then the setting at the high logic level is delayed due to the load off the filter capacitor. The delay generated by this capacitor avoid the priority conflict between the two research modes when there is a transition from one mode to the other.

The modules “ADAPTER 1” 16 and “ADAPTER 2” 18 format the signal. This signal takes the place of the signal provided by the command element of the fast forward and rewind element of the multimedia to drive. This adaptation concerns the shape of the signal, the polarity, the phase, the frequency, the power and the impedance. Then this signal takes the place of the signal provided by the command element of the “fasct forward” 19 and “rewind” 17 functions or the multimedia to drive.

Below, this is the calculation of the values used for the direction of rotation detection module illustrated FIG. 2:
F0, F0r, and F0sr frequency calculations: The F0 and F0sr frequency are contained in the audio bandwidth (20 hz to 20 Khz). F0 and F0sr will vary according to the pitch action. The standard pitch variation range is + or −12% when we use the pitch variation command of the turntable: for a “hand made” variation in the case of fast research or in the case of scratch the variation is bigger than the standard range. We choose F0 et F0sr in a way to stay in the audio signal bandwidth in spite or the pitch variation. The F0r frequency provide the F0sr envelop so we have F0r<<F0sr, with the F0r value according to: F0sr, and the refreshing rate of the driving system whished.
Calculation of the F1 cut off frequency from “FILTER 1” (3):

F1 is the low cut off frequency and is smaller than F0sr.
Calculation of the F2 cut off frequency:

F2 is calculated in order to allow the peak pulse detection for the smallest value of Fosr that is Fosrmin. That is the F2 value must be lower than F0srmin.
Calculation of the F3 cut off frequency:

F3 is calculated in order that the delay applied to the signal be about few miliseconds.

We describe in the following an application of the invention with a software type multimedia equipment, it means a computer, a PC for example (for personal computer) fitted by a editing creation software, of playing or reproduction of multimedia support.

There is many ways to realised the communication with the software: the information coming from the vinyl disk are digitalized then transmit to the computer via a communication port (serial or parallel). The data once recover are treated by programming in order to meet the functionality with the software. According to a variant, the information coming from the vinyl disk are transmit to the computer by a audio type input available on a sound acquisition card for computer. The data once recovered are treated by computing in order to meet it functionality with the software.

On the FIG. 1D, the F0 frequency sinusoidal signal, and the F0sr sinusoidal signal modulated in amplitude by a ramp shape signal with a F0r frequency can be contained on the same channel. The signal so obtained, has, in fact F0sr and F0 at de same value, and the amplitude modulation provided by the ramp shape signal doesn't modulate to a zero value of the sinusoidal signal.

The electrical diagram of the direction of rotation detection module doesn't change. The electrical diagram of the fast research detection module is modified at the amplifier “AMPLI 1” 3 level (FIG. 3), this amplifier will have its gain increased in order to obtain a clipped output voltage providing a constant level signal. The frequency to voltage converter “CONVERTER” 4, FIG. 3, convert either sinusoidal or square signal.

When the vinyl disc is played in the counter clockwise rotation the direction of rotation of the vinyl disc is detected thanks to the pulses provided by the output of “FILTER 2” 5, FIG. 2: a negatives pulses correspond to a clockwise (normal) playing rotation, and positives pulses correspond to a counter clockwise (reverse) playing rotation. To a reverse playing direction corresponds an action on the rewind of the audio multimedia support, or a reverse playing of the audio multimedia support if the multimedia is fitted by this function.

1. A digital audio machine slaving device, from a turntable holding a drive disk (101), of the category of device including a drive disk (101) designed to be rotated by a turntable on which it rests and which can be manipulated by the operator, the drive disk being linked to a data communication resource relating to its speed and rotation direction, which are linked to a data processing device (103) to drive the digital audio device, characterized:
in that, the turntable is that of a microgroove disk player equipped with a transducer, the drive disk (101) contains a microgroove (102) with at least one channel that is at least partially looped, to provide continuous data cycles from a regular asymmetric signal arranged at least along the microgroove channel, thus slaving the digital audio device, partly in terms of playing speed, the playing speed depending on the regularity of the signal from the drive disk, and partly in terms of the playing direction in accordance with the drive disk signal conformation that is progressively read in one direction or another from this signal by the microgroove disk player transducer.

2. Device according to claim 1, characterized:
in that the microgroove (102) has two channels (1B and 1C) each containing a signal, the signal (1B) from one of these channels corresponds with a sinusoidal signal to slave the digital audio player speed whilst the signal (1C) on the other channel corresponds with an asymmetric signal to slave the digital audio player rotation direction.

3. Device according to claim 1, characterized:
in that the microgroove (102) has one channel whereon the signal (1D) is a sinusoidal and asymmetric signal that can be used to slave the digital audio player speed as well as its direction.

4. Device according to claim 3, characterized:
in that the microgroove (102) has two channels, the signal (1D) on each of these channels being a sinusoidal and asymmetric signal that can be used alternately on these channels in the event that one of them should malfunction.

5. Device according to claim 3, characterized:
in that the microgroove (102) has two channels, one of the channels being allocated to slaving the digital audio device, whilst the other channel is allocated to slaving at least one supplementary digital device for the purpose of synchronized use.

6. Device according to claim 5, characterized:
in that the supplementary digital device is any special effects production device, including sound and visual effects, as well as slaving a supplementary digital audio device.

7. Device according to claim 6, characterized:
in that the slaving of the supplementary digital device is associated with a switching system for usage selection and for selecting the digital audio device from among a selection of associated supplementary digital audio devices.

8. Device according to any of the claims 3 and 4, characterized:
in that the sinusoidal wave of the signal (1D) constantly presents a significant value in order to avoid the loss of this signal by the microgroove disk transducer.

9. Device according to any of the aforementioned claims, characterized:
in that the digital audio device is either a player or recording device.
